(19) United States
(12) Patent Application Publication
(10) Pub. No.: US 2022/0271325 A1
(43) Pub. Date: Aug. 25, 2022

(54) BATTERY ASSEMBLY MEMBRANE APPLICATION

(71) Applicant: ADVANCED BATTERY CONCEPTS, LLC, Clare, MI (US)

(72) Inventor: Brian Sturdavant, Clare, MI (US)

(21) Appl. No.: 17/677,037

(22) Filed: Feb. 22, 2022

Related U.S. Application Data
(60) Provisional application No. 63/151,947, filed on Feb. 22, 2021.

(51) Int. Cl. H01M 10/04

(52) U.S. Cl. CPC H01M 10/0468

(57) ABSTRACT

A method for forming a bipolar battery assembly comprising: a) forming an electrode plate stack by stacking a plurality of electrode plates to create a plurality of electrochemical cells therebetween; b) applying the one or more membrane sheets to the one or more exterior surfaces such that the one or more membrane sheets conform to contours of the exterior surface and form a membrane of the bipolar battery assembly; and wherein the method includes one or more of the following: i) heating the one or more exterior surfaces of the electrode plate stack to form one or more preheated exterior surfaces prior to application of the one or more membrane sheets; ii) heating the one or more membrane sheets to form one or more heated membrane sheets prior to application of the one or more membrane sheets; and/or iii) drawing a vacuum from the electrode plate stack, after application of the one or more membrane sheets, to form fit the one or more membrane sheets to the one or more exterior surfaces to form the membrane. Heating may be found useful as preheating, simultaneous heating, and/or post heating in relation to the application of the one or more membrane sheets.

### FIELD

The present disclosure relates to a process for assembling a bipolar battery assembly. The present disclosure may find particular use in application of a membrane about the exterior of a stack of electrode plates to provide a seal bonded about the periphery.

BACKGROUND

Bipolar battery assemblies are typically formed as stacks of adjacent electrochemical cells. These batteries comprise a number of stacked electrode plates, with bipolar plates between and monopolar plates at opposing ends. The electrode plates are arranged in a stack such that anodic material of one plate faces cathodic material of the next plate. In most assemblies, there are battery separators located between the adjacent plates, which allow an electrolyte to flow from cathodic material to the anodic material. Disposed in the space between the plates is an electrolyte, which is a material that allows electrons and ions to flow between the anodic and cathodic material. The adjacent surfaces of the bipolar plates with the separator and the electrolyte disposed between the plates form an electrochemical cell where electrons and ions are exchanged between the anodic material and the cathodic material.

One of the main challenges presented by stacking electrode plates to form adjacent electrochemical cells is preventing flow of electrolyte out of the cell, maintaining a seal about the electrochemical cells before operation of the battery assembly (e.g., pulling a vacuum before or during filling with electrolyte which may cause the electrode plates to bow inward), and maintaining a seal about the electrochemical cells during operation of the battery assembly when there is a tendency for the battery assembly to bulge outward due to internal pressures.

Some bipolar battery assemblies may use a solid electrolyte to reduce the need for sealing about the battery assembly. While the use of solid electrolyte may resolve concerns with leaking, solid electrolyte generally does not perform as well as liquid electrolyte. As an example, solid electrolyte cannot achieve a high conductivity equal to or greater than that of a liquid electrolyte.

To use and seal a liquid electrolyte, some bipolar battery assemblies adhere adjacent electrode plates together at their abutting surfaces, provide for integrated edge seals, locate a membrane about the stack, or even use a protective case. Examples of such methods can be found in U.S. Pat. Nos. 8,357,469 and 10,141,598; and PCT Publication Nos.: WO 2013/062623, WO 2018/237381, and WO 2020/243093, incorporated herein by reference in their entirety for all purposes. Some of these features, like the bonding of adjacent electrode plates, may face difficulties in maintaining of the bond before and during operation while resisting inward buckling or outward bulging. On the other hand, some of these methods, like the integrated edge seal and membrane may be quite elegant solutions in commercial-scale manufacturing. Each of these processes tend to rely on custom tooling which is generally suitable for commercial scalability.

There is a need for a method for applying a membrane during prototyping of battery assemblies and small-scale production which is able to withstand tests performed on the battery assembly, inward buckling and outward bulging of the battery before and during operation, and which provides a repeatable application method. There is a need for developing a manner in which to apply a membrane about an exterior of an electrode plate stack such that it conforms to and is form-fitted about the exterior. What is needed is a membrane which can be bonded directly to a periphery of a stack of electrode plates, including frames of electrode plates. What is needed is a method which can allow for multilayer membranes to be formed about an exterior of the battery assembly.

### SUMMARY

The present teachings relates to a method for forming a bipolar battery assembly comprising: a) forming an electrode plate stack by stacking a plurality of electrode plates to create a plurality of electrochemical cells therebetween; b) applying the one or more membrane sheets to the one or more exterior surfaces such that the one or more membrane sheets conform to contours of the exterior surface and form a membrane of the bipolar battery assembly; and wherein the method includes one or more of the following: i) heating the one or more exterior surfaces of the electrode plate stack to form one or more heated exterior surfaces prior to application of the one or more membrane sheets; ii) heating the one or more membrane sheets to form one or more heated membrane sheets prior to application of the one or more membrane sheets; and/or iii) drawing a vacuum from the electrode plate stack, after application of the one or more membrane sheets, to form fit the one or more membrane sheets to the one or more exterior surfaces to form the membrane.

The method may include one or more of the following in any combination: heating may include preheat, simultaneous, and/or subsequent heating; the heating (preheating, simultaneous heating, post heating) of the one or more exterior surfaces, the one or more membrane sheets, or both may be completed by one or more heat sources; the one or more heat sources may include one or more convection heaters, radiant heaters, or a combination thereof; the one or more heat sources may include one or more infrared heaters, heat guns, or both; the one or more heat sources may include two or more heat sources, with at least one heat source associated with heating the one or more membrane sheets and at least another heat source associated with heating the one or more exterior surfaces; the one or more heat sources may heat (e.g., preheat) the one or more membrane sheets to between a glass transition temperature and a melting point of the one or more membrane sheets; the one or more heat sources may heat (e.g., preheat)the one or more exterior surfaces to temperature at or below a glass transition temperature of the one or more exterior surfaces; the one or more exterior surfaces, the one or more membrane sheets, or both may be heated (e.g., preheated) to a temperature of about 50° C. to about 275° C., about 50° C. to about 150° C., or about 55° C. to about 130° C.; the one or more membrane sheets may be heated (e.g., preheated) until softening and becoming flexible; the one or more membrane sheets may each be comprised of a single layer or plurality of layers of one or more membrane materials; the one or more membrane sheets comprise one or more membrane materials include one or more thermoplastics; the one or more membrane materials include polyethylene, polypropylene, ABS, polyester, the like, or a combination thereof; the one or more membrane sheets include a single membrane sheet or a plurality of membrane sheets; each individual membrane sheet of the plurality of membrane sheets may be sized to match a single side surface, end surface, or both of the electrode plate stack; the one or more exterior surfaces may include one or more side surfaces and two or more end surfaces; the single membrane sheet may be sized to cover each of the one or more side surfaces of the electrode plate stack onto which it is applied while leaving the two or more end surfaces free of one or more membrane sheets; the method may include bonding one or more edges of the one or more membrane sheets to one or more other edges of the one or more membrane sheets; wherein the one or more edges may be a leading edge and a trailing edge of a single membrane sheet; the one or more edges may be adjacent edges of two or more membrane sheets; forming of the electrode plate stack may include aligning and stacking the plurality of electrode plates such that one or more frames of one or more electrode plates align and interlock with one or more other frames of one or more adjacent electrode plates; the forming of the electrode plate stack may include aligning and stacking the plurality of electrode plates such that one or more inserts of one or more electrode plates align and interlock with one or more other inserts of one or more adjacent electrode plates, one or more adjacent separators, or both to form one or more channels passing through the electrode plate stack; the method may include forming the one or more membrane sheets; the forming of the one or more membrane sheets may include layering a plurality of membrane layers to form the one or more membrane sheets; the one or more membrane sheets are one or more laminates, composite laminates, or both; the one or more heat sources may be moved away from the one or more heated (e.g.., preheated) exterior surfaces, the one or more heated (e.g., preheated) membrane sheets, or both prior to the applying of the one or more heated (e.g., preheated) membrane sheets; the method may include applying subsequent heat while applying the one or more membrane sheets to the one or more exterior surfaces; the method may include drawing a vacuum from the electrode plate stack to form fit the one or more membrane sheets to the one or more exterior surfaces to form the membrane; the method may include inserting the electrode plate stack and the one or more membrane sheets into a vacuum chamber, affixing a vacuum pump to one or more channels extending through the electrode plate stack, or both before, during, and/or after preheating; the method may include evacuating about 1 psi or greater to about 13 psi or less from an interior of the electrode plate stack; applying the one or more heated (e.g., preheated) membrane sheets may include bonding one or more heated (e.g., preheated) membrane sheets to one or more other preheated membrane sheets, the one or more exterior surfaces, or both; the method may include cooling and solidifying the one or more heated (e.g., preheated) membrane sheets to form the membrane; the cooling and the solidifying occurs in an ambient environment, via air circulation, via fluid circulation, the like, or any combination thereof; the method may include removing excess material from the membrane that extends beyond the one or more exterior surfaces; the method may include filling the plurality of electrochemical cells with an electrolyte; and the electrolyte is a liquid electrolyte.

The present teachings provide for a method which may be useful for heating one or more membrane sheets until flexible and applying about an electrode plate stack to form a membrane. The method may provide a means, such as through the softness of the membrane sheet, application of external force, and/or even a vacuum, for the one or more membrane sheets to conform about and be form-fitted with the electrode plate stack. The method may allow for multilayer membrane sheets to be formed and used to create the membrane. The membrane of the present teachings may apply compressive force to the stack of electrode plates, aiding in resisting in inward buckling and/or outward bulging before and during operation of the battery assembly. The present teachings may provide a simple method with minimal tooling to allow for the formation of a membrane about the electrode plate stack.

### BRIEF DESCRIPTION OF DRAWINGS

FIG. 1A is a plan view of a plurality of sheets prior to application on an electrode plate stack.

FIG. 1B is a plan view of a battery assembly including a membrane.

FIG. 2A is a plan view of a sheet prior to application on an electrode plate stack.

FIG. 2B is a plan view of a sheet being applied to an electrode plate stack to form a membrane.

FIG. 2C is a plan view of a battery assembly including a membrane.

FIG. 3 is a perspective view of a battery assembly including a membrane.

FIG. 4 is a perspective view of a battery assembly affixed to a vacuum pump.

FIG. 5 is a partially exploded view of a stack of electrode plates.

FIG. 6 is a cross-section perspective view of a battery assembly.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### METHOD OF ASSEMBLING BATTERY

The present disclosure relates to a method for forming a battery assembly. The method may include forming one or more electrode plates; forming an electrode plate stack by stacking a plurality of electrode plates to create a plurality of electrochemical cells therebetween; applying one or more membrane sheets to the one or more exterior surfaces such that the one or more membrane sheets conform to contours of the exterior surface and form a membrane of the bipolar battery assembly; and wherein the method includes one or more of the following: i) heating (e.g., preheating) the one or more exterior surfaces of the electrode plate stack to form one or more preheated exterior surfaces prior to application of the one or more membrane sheets; ii) heating (e.g., preheating) the one or more membrane sheets to form one or more preheated membrane sheets prior to application of the one or more membrane sheets; and/or iii) drawing a vacuum from the electrode plate stack, after application of the one or more membrane sheets, to form fit the one or more membrane sheets to the one or more exterior surfaces to form the membrane.

The method may include forming one or more electrode plates. Forming one or more electrode plates may create one or more electrodes useful within the battery assembly. Forming one or more electrode plates may include forming and/or assembling one or more substrates, frames, inserts, active materials, transfer sheets, the like, or any combination thereof. Suitable methods for forming one or more electrode plates are discussed in PCT Publications WO 2013/062623, WO 2018/213730, WO 2018/237381, and WO 2020/102677; U.S. Pat. Nos. 8,357,469; 10,141,598, 10,615,393; and US Patent Publication No.: 2019/03790361 incorporated herein by reference in their entirety for all purposes.

The method may include forming an electrode plate stack. Forming an electrode plate stack may include aligning and stacking a plurality of electrode plates to form one or more electrochemical cells therebetween. One or more separators may be located between each pair of electrode plates. While aligning and stacking the plurality of electrode plates, the electrode plates and separators may be stacked in an alternating arrangement. One or more frames of one or more electrode plates may align and/or interlock with one or more frames of adjacent electrode plates and/or separators. A peripheral surface of the one or more frames may form part of an exterior surface of the electrode plate stack. One or more inserts of one or more electrode plates may align and/or interlock with one or more inserts of one or more other electrode plates and/or separators. Alignment and interlocking of a plurality of inserts may form one or more channels. The method may include or be free of forming an integrated edge seal.

Forming the electrode plate stack may include or be free of forming an integrated edge seal. The integrated edge seal may be formed after stacking one or more electrode plates within one or more other electrode plates, separators, or both. The one or more integrated edge seals may be formed by mating, engaging, and/or bonding one or more frames, raised edges, exterior surfaces, projections, or a combination thereof with one or more other projections, frames, raised edges, exterior surfaces, and/or the like of one or more adjacent electrode plates, separators, or both. The integrated edge seal may be formed by any method suitable for bonding one electrode plate to an adjacent electrode plate and/or separator. Bonding may include using a separate adhesive, melt-bonding, or both. Bonding may be performed by any method of welding. Welding may include heat welding, solvent welding, the like, or any combination. Welding may be achieved by heated platens, heat generated by friction or vibration, ultrasonic, radiofrequency, induction loop wire, solvent, the like, or any combination thereof. The weld or other bonding method may provide for a continuous integrated seal about the periphery of one or more electrochemical cells. The weld or other bonding method may provide a mechanically strong seal about the periphery of the one or more electrochemical cells. Exemplary methods for forming an integrated edge seal are discussed in PCT Publication No.: WO 2020/243093, which is incorporated herein by reference in its entirety for all purposes.

The method may include forming one or more membrane sheets. Forming one or more membrane sheets may function to form the one or more sheets which form the membrane. Forming one or more membrane sheets may include forming one or more membrane layers. One or more membrane layers may be formed from one or more membrane materials. Each of the one or more membrane layers may be a single membrane material or a plurality of membrane materials blended together. The one or more membrane layers may be one or more composites. The one or more membrane layers may be layered and/or bonded together to form a membrane sheet. The one or more membrane sheets may be one or more laminates, composite laminates, or both comprise of a plurality of membrane layers. The one or more membrane sheets may be formed by sheet-to-sheet, roll-to-sheet, and/or roll-to-roll lamination to form a continuous sheet of membrane material. A membrane sheet may be taken from a continuous sheet of a membrane material and cut to the desired length. A length may be a width of one or more side and/or end surfaces of an electrode plate stack. A membrane sheet may be formed with a width which matches a height of the electrode plate stack.

The method may include or be free of preheating one or more exterior surfaces of the electrode plate stack. Preheating the exterior surface may help in maintaining the preheated temperature and flexibility of one or more membrane sheets during application, allow one or more membrane sheets to be form-fitted to the exterior surface, or both. Preheating may be useful if one or more membranes are not preheated prior to application. Heat may be applied directly or indirectly. The heat source may be distanced from the exterior surface. The heat source may preheat the exterior surface to a temperature of about 50° C. or greater, about 60° C. or greater, about 70° C. or greater, or even about 80° C. or greater. The heat source may preheat the exterior surface to a temperature of about 275° C. or less, about 250° C. or less, about 200° C. or less, about 150° C. or less, about 140° C. or less, or even about 130° C. or less. The temperature may be less than a softening point (glass transition temperature) and/or melting point of all of the components of the electrode plate stack. The temperature may be less than, equal to, or greater than a glass transition temperature of one or more membrane sheets. The heat source may preheat the exterior surface to a temperature at which the electrode plates and/or separators still maintain their shape, strength, and/or other properties. The heat source may preheat the exterior surface to a temperature at which one or more membrane sheets soften. Preheating of the exterior surface may occur for about 30 seconds or more, about 1 minute or more, 3 minutes or more, or even 5 minutes or more. Preheating of the exterior surface may occur for about 20 minutes or less, about 15 minutes or less, or even about 10 minutes or less. After being preheated, the exterior surface may be a preheated exterior surface.

The method may include or be free of preheating one or more membrane sheets. Preheating the one or more membrane sheets may soften the sheets such that they are able to conform to the contours of an exterior surface, become form-fitted about the exterior surface, bond to one or more other membrane sheets, bond to one or more surfaces of an electrode plate stack, or any combination thereof Preheating may prove even more advantageous if an exterior of the stack is not preheated prior to application of the membrane sheets. Preheating may also be complementary to preheating an exterior of the stack prior to application of the membrane sheets. Heat may be applied directly or indirectly. The heat source may be distanced from the one or more membrane sheets. The heat source may preheat the one or more membrane sheets to a temperature of about 50° C. or greater, about 60° C. or greater, about 70° C. or greater, or even about 80° C. or greater. The heat source may preheat the one or more membrane sheets to a temperature of about 275° C. or less, about 250° C. or less, about 200° C. or less, about 150° C. or less, about 140° C. or less, or even about 130° C. or less. The temperature may be less than a melting point of the one or more membrane sheets. The temperature may be at or greater than a softening point (glass transition temperature) of the one or more membrane sheets. The heat source may preheat the one or more membrane sheets to a point at which they soften and are able to conform to the shape of the exterior surface. Preheating of the one or more membrane sheets may occur for about 30 seconds or more, about 1 minute or more, 3 minutes or more, or even 5 minutes or more. Preheating of the exterior surface may occur for about 20 minutes or less, about 15 minutes or less, or even about 10 minutes or less. After being preheated, the one or more membrane sheets may be one or more preheated membrane sheets.

Preheating of one or more exterior surfaces, one or more membrane sheets, or both may be completed by one or more heat sources. One or more heat sources may function to apply heat. One or more heat sources may apply heat directly and/or indirectly. Directly may be in direct contact with the exterior surfaces, membrane sheets, or both. Indirectly may be distanced from the exterior surfaces, membrane sheets, or both. The one or more heat sources may be distanced from the one or more exterior surfaces, one or more membrane sheets, or both while preheating. The distance may be about 10 cm or greater, about 15 cm or greater, or even about 20 cm or greater. The distance may be about 200 cm or less, about 150 cm or less, or even about 100 cm or less. One or more heat sources which preheat the one or more exterior surfaces may be the same or different as the one or more heat sources which preheat the one or more membrane sheets. One or more heat sources may be associated with preheating the one or more exterior surfaces. One or more other heat sources may be associated with preheating the one or more membrane sheets. One or more heat sources may include one or more dry heat sources, moist heat sources, or both. One or more heat sources may include convection heaters, radiant heaters, or a combination of both. One or more exemplary heat sources may include one or more heat guns, infrared heaters, the like, or a combination thereof.

The method may include applying one or more membrane sheets to the electrode plate stack. The one or more membrane sheets may include preheated membrane sheets, non-preheated (e.g., ambient) membrane sheets, or both. Application of the membrane sheets may allow for the membrane sheets to form a membrane about the electrode plate stack. The one or more membrane sheets may be fitted about the one or more exterior surfaces. Fitted may mean form-fitted, bonded to, forming reciprocal contours, the like, or a combination thereof. Fitted may mean overmolded. Applying one or more membrane sheets may include or be free of the application of additional force. The one or more membrane sheets may be sufficiently soft to conform to the contours of one or more exterior surfaces without the need for additional force. The one or more membrane sheets may require the application of additional force to conform to the contours. The application of additional force may be applied via one or more external mechanisms, internal mechanisms, or both. External mechanisms may include a clamp, mold, press, and/or the like. For example, the stack and membranes may be inserted into a mold, clamp, press, and/or the like. Heat may be applied to the one or more membrane sheets, exterior of the stack, or both prior to be inserted into, when located within, or both. Internal mechanisms may include drawing a vacuum in an interior of the battery assembly.

Applying one or more membrane sheets may include drawing a vacuum within the electrode plate stack. A vacuum may allow for the one or more membrane sheets to be drawn inward toward the one or more exterior surfaces, to conform to one or more contours of one or more exterior surfaces, to have a form-fit to one or more exterior surfaces, or any combination thereof Drawing a vacuum on the preheated or non-preheated one or more membranes may function like thermoforming, such as vacuum forming. A vacuum may allow for the one or more membrane sheets to become form-fitted, bonded, or both to the one or more exterior surfaces. A vacuum may allow for the one or more preheated membrane sheets to more quickly form the membrane. To draw a vacuum from the electrode plate stack, the stack with the one or more membrane sheets applied thereon may be placed within a vacuum chamber, affixed to a vacuum pump, or both. One or more channels may aid in drawing a vacuum. One or more channels may be in fluid communication with the space between the one or more membranes and the one or more exterior surfaces via one or more vents. One or more pumps may be in fluid communication with one or more channels such as to draw an internal vacuum. Drawing a vacuum may include an evacuation such that internal pressure within the electrode plate stack is below atmospheric pressure. Atmospheric pressure may be Earth's atmospheric pressure (14.7 psi). Drawing a vacuum may include an evacuation of about 1 psi or greater, about 3 psi or greater, or about 5 psi or greater (gauge pressure). Drawing a vacuum may include an evacuation of about atmospheric pressure or less, about 13 psi or less, 12 psi or less, or even 10 psi or less (gauge pressure). One or more reinforcement structures, end plates, monopolar plates, frames, inserts, posts, and the like may provide reinforcement against inward buckling while a vacuum is drawn. By drawing a vacuum, the one or more membrane sheets may be drawn further inward to conform and be form- fitted with the one or more exterior surfaces of the electrode plate stack. One or more heat sources may be applied before and/or simultaneously while a vacuum is drawn.

Applying one or more membrane sheets may include or be free of applying heat. Heat may maintain or warm the membrane sheets at a suitable temperature for forming into the membrane. Applying initial, simultaneous, or additional heat may include applying heat via one or more heat sources. Initial heat may be called preheating. Preheating may be prior to application of one or more membranes to a stack of electrode plates. Simultaneous heating may be during application of the one or more membranes to the stack. Additional heat may be after (e.g., post) application of one or more membranes to the stack. The one or more heat sources may be similar or the same as the one or more heat sources used for preheating the one or more membrane sheets, exterior surface, or both. The one or more heat sources may be moved into proximity of the electrode plate stack having the one or more membrane sheets located about.

Applying one or more membrane sheets may include bonding one or more membrane sheets to one or more other membrane sheets, the exterior surfaces of the electrode plate stack, or both. Bonding may function to create a unitary membrane, bond the membrane to the electrode plate stack, or both. One or more edges of one or more preheated membrane sheets may be bonded and/or sealed. One or more edges of a membrane sheet may be bonded to adjacent edges of the same or a different membrane sheet. For example, a leading edge to a trailing edge. As another example, abutting edges of two adjacent sheets. The edges can be sealed using adhesive bonding, melt bonding, vibration welding, RF welding, microwave welding, the like, or a combination thereof In melt bonding, the surface of the membrane sheet and/or the exterior surface of the stack are exposed to conditions at which the surface of one or both becomes molten and then the membrane sheet and the exterior surface of the stack are contacted while the surfaces are molten. The membrane and edge of the stack bond as the surface solidifies, forming a bond capable of sealing the components together. If the membrane sheet is bonded with an adhesive to the same or another membrane sheet and/or the stack of electrode plates, any adhesive that can withstand exposure to the electrolyte and the conditions of operation of the cell may be used. Exemplary adhesives are plastic cements, epoxies, cyanoacrylate glues or acrylate resins.

The method for forming a battery assembly may include cooling and solidifying the one or more membrane sheets (e.g., preheated membrane sheets) to form the membrane. By cooling and solidifying, the one or more membrane sheets may be able to impart strength and rigidity upon the battery assembly as the membrane. Cooling and solidifying may occur in an ambient environment, via air circulation, via fluid circulation, the like, or any combination thereof Cooling and solidifying may include removing one or more heat sources, applying cooling fluid (e.g., air and/or liquid), or both. Cooling fluid may include circulating air, liquid, or both about the battery assembly, within the battery assembly, or both. Circulating air may provided by one or more air circulation devices (e.g., fans). Cooling fluid may include applying a cooling fluid. Exemplary cooling fluid may include a liquid mist, such as a water mist. Cooling fluid may be applied via one or more nozzles.

One or more electrochemical cells may be filled with electrolyte after applying one or more membranes. The battery assembly may be filled with electrolyte such as disclosed in PCT Publication WO 2013/062623 and U.S. Pat. No.: 10,141,598, incorporated herein by reference in their entirety.

### BATTERY ASSEMBLY

The battery assembly of the disclosure generally relates to a battery assembly. The battery assembly may function to store, produce, and/or release electric energy. The battery assembly of the present teachings may find particular use as a bipolar battery assembly. The battery assembly may be assembled based on the method of the present teachings. The battery assembly may include a plurality of electrode plates, one or more membranes, one or more cases, one or more electrochemical cells, one or more separators, one or more inserts, one or more openings, one or more channels, one or more seals, one or more posts, one or more valves, one or more terminals, one or more conductive conduits, the like, or any combination thereof.

The battery assembly includes one or more membranes. The membrane may function to seal about the exterior surfaces (periphery) of one or more end plates, plurality of electrode plates, one or more separators, one or more transfer sheets, one or more channels, or any combination thereof The membrane may isolate one or more electrochemical cells. The membrane may cooperate with one or more frames or function on its own to isolate one or more electrochemical cells. By isolating one or more electrochemical cells, the one or more membranes may prevent electrolyte from leaking from the cells and causing short-circuiting. The membrane may apply one or more compressive forces on the electrode plate stack. The compressive forces may reinforce the electrode plate stack such as to resist against outward bulging, inward contracting/buckling, or both that may occur during charging, discharging, and/or operation of the battery assembly. The one or more membranes may be affixed to an electrode plate stack. The one or more membranes may be affixed by being bonded thereon, having a friction and/or interference fit, being affixed via one or more mechanical attachments, the like, or any combination therein. The one or more membranes may be in direct contact with one or more exterior surfaces of the electrode plate stack. Exterior surfaces may include one or more side surfaces, end surfaces, or both. The one or more membranes may be bonded to one or more exterior surfaces of the electrode plate stack. The one or more membranes may be bonded to one or more exterior surfaces of the electrode plate stack without the use of adhesives. The one or more membranes may be molded onto (e.g., overmolded) one or more exterior surfaces. The exposed surfaces may include one or more exterior surfaces of one or more end plates and/or monopolar plates; one or more exterior surfaces of one or more electrode plates; separators, and/or transfer sheets, or any combination thereof. The one or more membranes may be formed by one or more membrane sheets, comprise one or more membrane layers, be comprised of one or more membrane materials, include one or more protective coverings, or any combination thereof.

The one or more membranes may be formed by one or more membrane sheets. The one or more membrane sheets may function to form a membrane at least partially about an electrode plate stack to form the battery assembly. The one or more membrane sheets may have a cross-sectional shape reciprocal with the cross-sectional shape of one or more exterior surfaces of an electrode plate stack. The one or more membrane sheets may be the size (e.g., length and width) as one or more exterior surfaces of the electrode plate stack to which it is bonded. The one or more membrane sheets may have a cross-sectional shape similar (substantially the same as) to one or more side surfaces, end surfaces, or both of the electrode plate stack. For example, one or more membrane sheets may have a substantially square and/or rectangular shape to match a substantially square and/or rectangular shape of one or more side surfaces, end surfaces, or both. One or more membrane sheets may have one or more cuts and/or creases formed therein to allow for having a shape substantially similar to all or a portion of an exterior shape of a stack of electrode plates. The one or more membrane sheets may include a single membrane sheet or a plurality of membrane sheets. A membrane sheet may refer to a protective covering. A single membrane sheet may be associated with a single side, some of the sides, or even all of the sides of an electrode plate stack. For example, an individual membrane sheet may only be bonded to a single side surface. A plurality of membrane sheets may be utilized to cover a plurality of side surfaces. As another example, an individual membrane sheet may be bonded to a plurality of side surfaces. A single membrane sheet may be utilized to cover a plurality of side surfaces. A single membrane sheet may cover and/or be bonded to all side surfaces of the electrode plate stack. If a different membrane sheet is utilized to cover an end surface, it may be referred to as a protective covering. A same or a different membrane sheet which is affixed to one or more side surfaces may be bonded to one or more edges of the same or a different membrane sheet.

One or more edges of one or more membrane sheets may be sealed. Sealing the edges may complete the seal about the electrode plate stack. Sealing the edges may create a continuous membrane about a periphery of an electrode plate stack. One or more edges of one or more membrane sheets may be bonded to one or more edges of the same or other membrane sheets, an exterior surface of the electrode plate stack, or both. A leading edge of a membrane sheet may be bonded to an opposite trailing edge of the same membrane sheet. For example, the membrane may be comprised of a single membrane sheet which is wrapped about the entire periphery of the stack such that the leading edge is bonded to the trailing edge. The leading edge may be the first edge of the membrane sheet in contact with the electrode plate stack. The trailing edge may be the last edge of the membrane sheet applied to the electrode plate stack. An edge of a membrane sheet may be bonded to an adjacent edge of another membrane sheet. For example, the membrane may be comprised of a plurality of membrane sheets which are adjacent to one another. By bonding the edges of the membrane sheet, a unitary membrane is formed about the electrode plate stack.

The width of the membrane sheet may match and/or be greater than the height of the electrode plate stack. The height of the electrode plate stack may be the distance from the exterior surface of one monopolar plate to an exterior surface of the opposing monopolar plate. The width of the membrane sheet, in at least a portion, may have a height equal to the height of the electrode plate stack plus the respective height of two monopolar plates. The one or more membrane sheets may have a sufficient thickness to seal the edges of the electrode plate stack to seal the electrochemical cells. The one or more membrane sheets and/or membrane may have a thickness of about 1 mm or greater, about 1.6 mm or greater or about 2 mm or greater. The one or more membrane sheets and/or membrane may have a thickness of about 5 mm or less, 4 mm or less or about 2.5 mm or less.

The one or more membrane sheets may be comprised of one or more membrane layers. The one or more membrane layers may allow for different materials and their properties to cooperate together to provide a membrane. The one or more membrane layers may include a single layer or a plurality of layers. The one or more membrane layers may include 1 or more, 2 or more, or even 3 or more layers. The one or more membrane layers may include 10 or less, 7 or less, or even 5 or less layers. A plurality of membrane layers may be formed by lamination such that the membrane layers are a laminate material. Each membrane layer may be formed from one or more membrane materials. One or more membrane layers may be comprised of the same or different membrane materials as one or more other membrane layers.

The one or more membrane sheets may be comprised of one or more membrane materials. The one or more membrane materials may be any material which can withstand exposure to electrolyte, the conditions the battery assembly is exposed to internally and externally, or both. The one or more membrane materials may be any material which is able to be sealed to and/or bonded to one or more exterior surfaces of an electrode plate stack. The one or more membrane materials may be nonconductive. The one or more membrane materials may include one or more polymeric materials. The one or more membrane materials may include one or more thermoplastic materials, thermoset materials, or both. Thermoplastic material may be beneficial in cooperating with the preheating and application steps of the method of the present teachings. One or more membrane materials may include polycarbonate, acrylonitrile butadiene styrene (ABS), acetal copolymer polyoxymethylene, acetal homopolymer polyoxymethylene, acrylic, polyamide (nylon), polyethylene, polypropylene, polystyrene, polyvinyl chloride (PVC), Teflon, the like, or any combination thereof. One or more membrane materials may include one or more materials in common with a substrate of one or more electrode plates.

The battery assembly may be free of a separate case. The membrane on its own and/or in conjunction with the monopolar plates, separate end plates, and/or exterior surfaces of electrode plates (e.g., frames) may function to protect the battery assembly. The monopolar plates may have an additional protective cover attached thereto. The protective cover may be separate end plates, a protective covering, or both. A protective covering may be one or more membrane sheets. The protective covering may be bonded to the membrane and/or be part of the membrane. For example, the protective covering may be bonded about all its peripheral edges to one or more membrane sheets located about the periphery of the electrode plate stack. The protective covering may be bonded so as to be integrated with the membrane. The monopolar plates and/or end plates may have their reinforcement structures exposed and be free of a protective covering and/or end plate.

Alternatively, the battery assembly may include a case separate from the membrane. A sealed battery assembly may be placed in a case to protect the formed battery. If affixed to end plates and/or monopolar plates, the case may be affixed with any mechanical attachment. The mechanical attachment may include the posts having overlapping portions. The battery assembly may be free of a case. A method of forming a battery assembly may be free of disposing the stack of electrode plates, the battery assembly, or both within a case.

A battery assembly may include one or more electrochemical cells. An electrochemical cell may be formed by a pair of opposing electrode plates with an opposing anode and cathode pair therebetween. The space of an electrochemical cell (i.e., between an opposing anode and cathode pair) may contain one or more separators, transfer sheets, electrolyte, or a combination thereof One or more electrochemical cells may be sealed. The electrochemical cells may be sealed through one or more seals formed about the periphery of the electrode plate stack, such as by a membrane and/or interlocking of frames, one or more channels, or both which may form closed electrochemical cells. The membrane may provide a liquid tight seal, gas tight seal, or both about one or more electrochemical cells. The closed electrochemical cells may be sealed from the environment to prevent leakage and short circuiting of the cells.

The battery assembly may include a plurality of electrode plates. An electrode plate may function as one or more electrodes, include one or more electroactive materials, be part of an electrochemical cell, form part of one or more sealing structures, or any combination thereof A plurality of electrode plates may function to conduct an electric current (i.e., flow of ions and electrons) within the battery assembly. A plurality of electrode plates may form one or more electrochemical cells. For example, a pair of electrode plates, which may have a separator and/or electrolyte therebetween, may form an electrochemical cell. The number of electrode plates present can be chosen to provide the desired voltage of the battery. The battery assembly design provides flexibility in the voltage that can be produced. The plurality of electrode plates can have any desired cross-sectional shape and the cross-sectional shape can be designed to fit the packaging space available in the use environment. Cross-sectional shape may refer to the shape of the plates from the perspective of the faces of the sheets. Flexible cross-sectional shapes and sizes allow preparation of the assemblies disclosed to accommodate the voltage and size needs of the system in which the batteries are utilized. Opposing end plates and/or monopolar plates may sandwich a plurality of electrode plates therebetween. The plurality of electrode plates may include one or more bipolar plates, monopolar plates, dual polar plates, the like, or any combination thereof Suitable electrode plates are disclosed in PCT Publications WO 2013/062623, WO 2018/213730, WO 2018/237381, and WO 2020/102677; U.S. Pat. Nos. 8,357,469; 10,141,598, 10,615,393; and US Patent Publication No.: 2019/03790361 incorporated herein by reference in their entirety for all purposes.

A stack of electrode plates may be referred to as a stack or an electrode plate stack. An electrode plate stack may generally comprise a plurality of bipolar electrode plates between opposing monopolar plates. An electrode plate stack may include one or more dual polar plates located between a plurality of bipolar electrode plates. An electrode plate stack may include a height. A height may be a distance between one end to the other end, from an exterior surface of a monopolar end plate to an exterior surface of an opposing monopolar end plate. An electrode stack may include one or more side surfaces (“sides”) and end surfaces. End surfaces may be formed by exterior and opposing surfaces of one or more end plates, monopolar plates, or both. One or more side surfaces may define the periphery of the electrode plate stack. One or more side surfaces and end surfaces may be one or more exterior surfaces.

One or more electrode plates include one or more substrates. One or more substrates may function to provide structural support for the active material; as a cell partition, to prevent the flow of electrolyte between adjacent electrochemical cells; cooperating with other battery components to form an electrolyte-tight seal about the electrode plate edges, which may be on the outside surface of the battery; and, in some embodiments, to transmit electrons from one surface to the other. The substrate can be formed from a variety of materials depending on the function or battery chemistry. The substrate may be formed from materials that are sufficiently structurally robust to provide the backbone of a desired electrode plate, withstanding temperatures that exceed the melting points of any conductive materials used in the battery construction, and having high chemical stability during contact with an electrolyte (e.g., sulfuric acid solution) so that the substrate does not degrade upon contact with an electrolyte. The substrate may be formed from suitable materials and/or is configured in a manner that permits the transmission of electricity from one surface of the substrate to an opposite substrate surface. The substrate may be formed from an electrically conductive material, e.g., a metallic material, and/or can be formed from an electrically non- conductive material. Exemplary non-conductive material may include polymers, such as thermoset polymers, elastomeric polymers, thermoplastic polymers, or any combination thereof The substrate may comprise a generally non-electrically conductive substrate (e.g., a dielectric substrate). The non-conductive substrate may have electrically conductive features constructed therein or thereon. Examples of polymeric materials that may be employed include polyamide, polyester, polystyrene, polyethylene (including polyethylene terephthalate, high density polyethylene and low-density polyethylene), polycarbonates (PC), polypropylene, polyvinyl chloride, bio-based plastics/biopolymers (e.g., polylactic acid), silicone, acrylonitrile butadiene styrene (ABS), or any combination thereof, such as PC/ABS (blends of polycarbonates and acrylonitrile butadiene styrenes). Composite substrates may be utilized. The composite may contain reinforcing materials, such as fibers or fillers commonly known in the art; two different polymeric materials, such as a thermoset core and a thermoplastic shell or thermoplastic edge about the periphery of the thermoset polymer; or conductive material disposed in a non-conductive polymer. The substrate may comprise or have at the edge of the plates a thermoplastic material that is bondable, preferably melt bondable. The one or more substrates may have one or more nonplanar structures. The one or more nonplanar structures may be integral with the substrate or affixed to the substrate. The one or more nonplanar structured may be molded as part of the substrate. The one or more nonplanar structures may include one or more raised edges, frames, inserts, projections, openings, the like, or any combination thereof

One or more substrates may have a raised edge about the periphery so as to facilitate stacking of the electrode plates and formation of electrochemical cells. The raised edge as used in this context means a raised edge on at least one of the two opposing surfaces of the substrates. The raised edge may comprise a thermoplastic edge portion formed about another substrate material. The raised edge may function with separator plates as described herein. The substrate or periphery of the substrate may be a non- conductive material and may be a thermoplastic material. One or more substrates may include a frame. The frame may or may not include the raised edge. The frame may refer to the raised edge. The frame may be about a periphery of a substrate. The frame may be affixed to and/or integral with the substrate. The frame may be comprised of non-conductive material, such as a thermoplastic material. The use of non-conductive material enhances sealing the outside of the battery stack. The frame may be used to form an integrated edge seal. Exemplary frame structures are disclosed in PCT Publication No. WO 2013/062623 and WO 2020/243093 and U.S. Pat. No. 10,141,598 which are incorporated herein by reference in their entirety. Raised edges of the electrode plates may align and interlock with one another to form a common edge of the electrode plate stack, and to enhance the seal between the electrochemical cells and the outside of the battery. Raised edges of the electrode plates may form the sides surfaces of the exterior of the electrode plate stack.

The battery assembly may include one or more integrated edge seals. The one or more integrated edge seals function to cooperate with a membrane, provide a seal about one or more electrochemical cells, prevent separation of one or more electrode plates and/or separators from one another, or both. The integrated edge seal may be particularly useful in forming a liquid tight seal, gas tight seal, or both about a plurality of electrochemical cells. The one or more integrated edge seals may be formed by one or more projections, electrode plates, separators, or any combination thereof. The integrated edge seal may be formed about a portion or all of a periphery of an electrochemical cell. The integrated edge seal may be formed about the peripheral edge all about an electrochemical cell. The peripheral edge may be the joint and/or seam defined by adjacent electrode plates, separators, or both which form an electrochemical cell. The one or more integrated edge seals may be comprised of any material suitable for being exposed to electrolyte. The one or more integrated edge seals may be formed by the same material suitable for one or more substrates, frames, raised edges, projections, separators, the like, or a combination thereof. An exemplary and suitable integrated edge seal may be that disclosed in PCT Publication No.: WO 2020/0243093, incorporated herein by reference for all purposes.

One or more of the electrode plates may include one or more active materials. The one or more active materials may function as a cathode or an anode of the electrode plate. The one or more active materials may be any form commonly used in batteries to function as an anode, cathode, or both. A bipolar plate may have one or more active materials on a surface functioning as a cathode and one or more active materials on an opposing surface functioning as an anode. A monopolar plate may have one or more active materials on a surface functioning as a cathode or an anode while the opposing surface is bare of both an anode and cathode. A dual polar plate may have one or more active materials on a surface functioning as a cathode or an anode, while one or more similar active materials are on the opposing surface also functioning as a cathode or an anode. The cathode of one electrode plate may be opposing the anode of another electrode plate. Suitable active materials and forms are disclosed in PCT Publication Nos.: WO 2013/062623, WO 2018/213730, and WO 2020/102677 and U.S. Pat. No. 10,141,598 incorporated herein by reference in their entirety.

A battery assembly may include an electrolyte. The electrolyte may allow electrons and ions to flow between the anode and cathode. The electrolyte may be located within the electrochemical cells. As the one or more electrochemical cells may be sealed, the electrolyte may be a liquid electrolyte. The electrolyte can be any liquid electrolyte that facilitates an electrochemical reaction with the anode and cathode utilized. A liquid electrolyte may be advantageous over a solid or gel electrolyte as it may provide for improved conductivity with greater surface area contact with active materials, allows for interior volume changes during operation of the battery (e.g., due to expansion, bending, bulging, etc.), and provides for easier flow within the electrochemical cell. The electrolyte may be able to pass through one or more separators, transfer sheets, or both of an electrochemical cell. The electrolyte may be sealed from leaking to an exterior of a battery assembly by one or more membranes, frames, integrated edge seals, the like, or a combination thereof. Suitable forms of electrolyte are disclosed in PCT Publication Nos.: WO 2013/062623, WO 2018/213730, and WO 2020/243093, WO 2020/102677 and U.S. Pat. No. 10,141,598 incorporated herein by

The battery assembly may include or be free of one or more separators. The one or more separators may function to partition an electrochemical cell (i.e., separate a cathode of an electrochemical cell from an anode of an electrochemical cell); prevent short circuiting of the cells due to dendrite formation; allow liquid electrolyte, ions, electrons or any combination of these elements to pass through; or any combination thereof Any known battery separator which performs one or more of the recited functions may be utilized in the battery assemblies of the present teachings. One or more separators may be located between anode and a cathode of an electrochemical cell. One or more separators may be located between a pair of adjacent electrode plates, which may include between bipolar plates, between a bipolar plate and a monopolar plate, or between a bipolar plate and dual polar plate. The separator may be prepared from a non-conductive material, such as porous polymer films, glass mats, porous rubbers, ionically conductive gels or natural materials, such as wood, and the like. The separator may contain pores or tortuous paths through the separator which allows electrolyte, ions, electrons or a combination thereof to pass through the separator. Among exemplary materials useful as separators are absorbent glass mats (AGM), and porous ultra-high molecular weight polyolefin membranes and the like. Exemplary separators useful in the battery assembly include those in WO 2013/062623, WO 2018/213730, WO 2018/237381, and WO 2020/102677; U.S. Pat. Nos. 8,357,469; 10,141,598, 10,615,393; and US Patent Publication No.: 2019/03790361incorporated herein by reference in its entirety. The use of one or more transfer sheets within an electrochemical cell may allow for the electrochemical cell to be free of a separator if desired.

One or more separators may include or be free of one or more frames. The frames may function to match with the edges or frames of adjacent electrode plates and form a seal between the electrochemical cells and the outside of the battery. The frame may be attached to or integral with a separator. The frame can be attached to the separator about the periphery of the sheet forming the separator using any means that bonds the separator to the frame and which can withstand exposure to the electrolyte solution. For example, the frame may be attached by adhesive bonding, melt bonding or molding the frame about the periphery of the separator. The frame can be molded in place by any known molding technic, for example thermoforming, injection molding, roto molding, blow molding, compression molding and the like. The frame may be formed about the separator sheet by injection molding. The frame may contain a raised edge adapted to match raised edges disposed about the periphery of the substrates for the electrode plates. Raised edges in one or both of the electrode plate substrates and the frames of the separators can be matched to form a common edge for the battery stack and to enhance the seal between the electrochemical cells and the outside of the battery. A frame of a separator may not extend completely toward the exterior periphery of the battery stack while being interlocked with frames of adjacent electrode plates. Frames of the electrode plates may form the common edge due to the separator frame being located inward of the periphery. By being free of one or more frames, one or more separators may be able to be disposed within an interior of an electrode plate. By the separators being free of one or more frames, raised edges of the electrode plates may be able to tightly interlock to form the common edge.

The battery assembly may include one or more inserts. One or more inserts may include a plurality of inserts. The one or more inserts may function to interlock with one or more other inserts, define a portion of one or more channels passing through the stack, form leak proof seal along one or more channels, cooperate with one or more valves, or any combination thereof One or more inserts may be part of one or more end plates, electrode plates, separators, or any combination thereof. One or more inserts may be free of active material, transfer sheet, or both. The one or more inserts may pass through active material. The one or more inserts may have any size and/or shape to interlock with one or more inserts of an electrode plate, end plate, separator, or combination thereof; form a portion of a channel, form a leak proof seal along one or more channels, cooperate with one or more valves, or any combination thereof The one or more inserts may be formed or attached to an end plate, substrate of an electrode plate, separator, or combination thereof. The one or more inserts may be located within the periphery of an electrode plate, separator, end plate, or combination thereof. One or more inserts may project from a surface of a substrate, separator, end plate, or combination thereof thus forming one or more raised inserts. One or more inserts may project from a substrate of an electrode plate, a central portion of a separator, or both. One or more inserts may project substantially orthogonally or oblique from a surface of the substrate, separator, end plate, or combination thereof. One or more inserts may be attached to or integral with a portion of the electrode plate, separator, end plate, or combination thereof An insert which is integral with and projects from a surface may be defined as a boss. The opposing surface from which the insert projects therefrom may have a reciprocal indentation to allow forming of the boss. The reciprocal indentation may receive another insert therein, thus allowing formation of a channel The one or more inserts may have one or more openings therethrough. The one or more inserts may be concentric and formed about one or more openings. One or more inserts may extend a length of an opening. A sealing surface may be formed between the outer diameter of one or more openings and an interior of one or more inserts. For example, a surface of the substrate, end plate, and/or separator may be substantially perpendicular to a longitudinal axis of the battery assembly located between an insert and an opening may be a sealing surface. One or more inserts may be capable of interlocking with one or more inserts of an adjacent electrode plate, separator, and/or end plate to form a leak proof seal about a channel For example, one or more electrode plates may be machined or formed to contain matching indents, on a surface opposite from an insert, for bosses, inserts, sleeves, or bushings of a separator, electrode plate, and/or end plate. One or more suitable inserts may be those disclosed in U.S. Pat. Nos. 8,357,469; 9,553,329; and US Patent Application Publication No. 2017/0077545; incorporated herein by reference in their entirety for all purposes. One or more inserts may contain one or more vent holes. The one or more vent holes may allow communication of selected fluids from one or more electrochemical cells to one or more channels.

The battery assembly may include one or more openings The one or more openings may include a plurality of openings. The openings may function to form one or more channels; house one or more seals; affix one or more end plates, electrode plates, separators, or combination thereof to one another; or any combination thereof The one or more openings may be formed in one or more of the end plates, electrode plates, separators, active material, transfer sheets, or any combination thereof One or more openings of an end plate, electrode plate, separator, active material, transfer sheet, or combination thereof may align (i.e., be substantially concentric) with one or more openings of one or more other end plates, electrode plates, separators, active material, transfer sheet, or any combination thereof The one or more openings may align in a transverse direction across the length of the battery assembly. The transverse direction may be substantially parallel to a longitudinal axis of the article. The transverse direction may be substantially perpendicular the opposing surfaces of the substrates upon which a cathode and/or anode may be deposited. The openings may be machined (e.g., milled), formed during fabrication of the substrate (e.g., by a molding or shaping operation), or otherwise fabricated. Openings in a paste may be formed during a past application process. The openings may have straight and/or smooth internal walls or surfaces. The size and frequency of the openings formed in the substrate may affect the resistivity of the battery. The one or more openings may have a diameter able to receive a post therethrough. One or more openings in an active material and/or transfer sheet may have a diameter able to receive a post, an insert, or both therethrough. The openings may have a diameter of about 0.2 mm or greater, about 1 mm or greater, about 2 mm or greater, or even about 5 mm or greater. The openings may have a diameter of about 30 mm or less, about 25 mm or less, or even about 20 mm or less. One or more openings of a transfer sheet and/or active material (e.g., paste) may have a diameter larger than a diameter of an opening and/or insert of a separator, substrate, electrode plate, end plate, or combination thereof One or more openings of an electrode plate and/or substrate may have a larger diameter than one or more other openings of the same electrode plate and/or substrate. An opening may be about at least about 1.5 times, at least about 2 times, or even at least about 2.5 times larger than another opening. An opening may be about 4 times or less, about 3.5 times or less, or even about 3 times or less larger than another opening. The openings may be formed having a density of at least about 0.02 openings per cm². The openings may be formed having a density of less than about 4 openings per cm². The openings may be formed having a density from about 2.0 openings per cm² to about 2.8 openings per cm².

One or more openings may be filled with an electrically conductive material, e.g., a metallic-containing material. The electrically conductive material may be a material that undergoes a phase transformation at a temperature that is below the thermal degradation temperature of the substrate so that at an operating temperature of the battery assembly that is below the phase transformation temperature, the dielectric substrate has an electrically conductive path via the material admixture between the first surface and the second surface of the substrate. At a temperature that is above the phase transformation temperature, the electrically conductive material admixture may undergo a phase transformation that disables electrical conductivity via the electrically conductive path. The electrically conductive material may be or include a solder material, e.g., one comprising at least one or a mixture of any two or more of lead, tin, nickel, zinc, lithium, antimony, copper, bismuth, indium, or silver. The type of electrically conductive material selected fill the openings can vary depending on whether it is desired to include such an internal shut down mechanism within the battery, and if so at what temperature it is desired to effect such an internal shutdown. The substrate will be configured so that in the event of operating conditions that exceed a predetermined condition, the substrate will function to disable operation of the battery by disrupting electrical conductivity through the substrate. For example, the electrically conductive material filling holes in a dielectric substrate will undergo a phase transformation (e.g., it will melt) so that electrical conductivity across the substrate is disrupted. The extent of the disruption may be to partially or even entirely render the function of conducting electricity through the substrate disabled. Suitable openings and electrically conductive material can be found in U.S. Pat. No. 8,357,469 incorporated herein by reference in their entirety.

The battery assembly may include one or more channels. The one or more channels may function as one or more venting, filling, and/or cooling channels; house one or more posts; distribute one or more posts throughout an interior of the battery assembly; prevent liquid electrolyte from coming into contact with one or more posts or other components; or any combination thereof The one or more channels may be formed by one or more openings of one or more end plates, electrode plates, and/or separators, which are aligned. The one or more channels may extend and pass through one or more electrochemical cells, end plates, electrode plates, separators, active material, electrolyte, the like, or a combination thereof. The one or more channels may be referred to as one or more integrated channels. The channels may be sealed to prevent electrolytes and gasses evolved during operation from entering the channels. Any method of sealing which achieves this objective may be utilized. One or more seals, such as inserts of the one or more end plates, electrode plates, and/or separators, may interlock and surround one or more channels to prevent the liquid electrolyte from leaking into one or more channels. The one or more channels may pass through the battery assembly in a transverse direction to form one or more transverse channels. The size and shape of the channels can be any size or shape that allows them to house one or more posts. The shape of the channels may be round, elliptical, or polygonal, such as square, rectangular, hexagonal and the like. The size of the channels housing one or more posts is chosen to accommodate the posts used. The interior diameter of the channel may be equal to the diameter of the openings which align to form one or more channels. The one or more channels comprise a series of openings in the components arranged so a post can be placed in the channel formed, so a fluid can be transmitted through the channel for cooling, and/or for venting and filling. The number of channels is chosen to support the end plate and edges of the end plates, electrode plates, and separators to prevent leakage of electrolyte and gasses evolved during operation, and to prevent the compressive forces arising during operation from damaging components and the seal for the individual electrochemical cells. A plurality of channels may be present so as to spread out the compressive forces generated during operation. The number and design of channels is sufficient to minimize edge-stress forces that exceed the fatigue strength of the seals. The locations of a plurality of channels are chosen so as to spread out the compressive forces generated during operation. The channels may be spread out evenly through the stack to better handle the stresses. The plurality of channels may have a cross-sectional width and/or diameter of about 2 mm or greater, about 4 mm or greater, or about 6 mm or greater. The upper limit on the cross-sectional size of the channels is practicality. If the size is too large, the efficiency of the assemblies is reduced. The channels may have a cross-sectional width and/or diameter of about 30 mm or less, about 25 mm or less, or even about 20 mm or less.

The battery assembly may or may not comprise a separate seal between one or more channels and one or more posts. One or more seals may be located in a channel, about an exterior of a channel, and/or about a post. The seal may comprise any material or form that prevents electrolyte and gasses evolved during operation from leaking from the electrochemical cells. The seal can be a membrane, sleeve, or series of matched inserts in the end plates, electrode plates, and/or separators, or inserted in the channel The membrane can be elastomeric.

The battery assembly may include one or more posts. The one or more posts may function to hold the stack of components together in a fashion such that damage to components or breaking of the seal between the edges of the components of the stack is prevented, ensure uniform compression across the separator material, and ensure uniform thickness of the separator material. The one or more posts may have on each end an overlapping portion which engages the outside surface of opposing end plates, such as a sealing surface of each end plate. The overlapping portion may function to apply pressure on outside surfaces of opposing end plates in a manner so as to prevent damage to components or breaking of the seal between the edges of the components of the stack, and prevent bulging or other displacements of the stack during battery operation. The overlapping portion may be in contact with a sealing surface (e.g. exterior surface, end surface) of an end plate. The plurality of posts may be present so as to spread out the compressive forces generated during operation. There may be fewer posts than channels where one or more of the channels are utilized as cooling channels or vent/fill channels. For example, there may be four channels with three channels having a post located therein and one channel may be used as a cooling, vent, and/or fill channel Suitable posts are disclosed in U.S. Pat. No. 10,141,598 incorporated herein by reference in their entirety for all purposes.

The battery assembly may include one or more valves. The one or more valves may function to draw a vacuum from an interior of the battery assembly, fill the battery assembly with an electrolyte, and/or vent the battery assembly during operation. The one or more valves may include a pressure release valve, check valve, fill valve, pop valve, and the like, or any combination thereof The one or more valves may be connected to and/or in communication with one or more channels formed by one or more openings of an end plate, electrode plate, separator, or any combination thereof The one or more valves may be in communication with a channel, such as a channel having a post there through or free of a post. The article may include one or more valves as described in US Patent Publication No. 2014/0349147 and U.S. Pat. No. 10,141,598, incorporated herein by reference in its entirety for all purposes. The assembly may contain pressure release valves for one or more of the cells to release pressure if the cell reaches a dangerous internal pressure. The pressure release valves are designed to prevent catastrophic failure in a manner which damages the system the battery is used with. Once a pressure release valve is released the battery is no longer functional. The assemblies disclosed may contain a single check valve which releases pressure from the entire assembly when or before a dangerous pressure is reached. Some exemplary suitable valves are disclosed in U.S. Pat. Nos. 8,357,469; 9,553,329; 9,685,677; 9,825,336; and US Patent Application Publication No.: 2018/0053926; incorporated herein by reference in their entirety for all purposes.

The article may include one or more terminals. The assembly may contain one or more pairs of conductive terminals, each pair connected to a positive and negative terminal. The one or more terminals may function to transmit the electrons generated in the electrochemical cells to a system that utilizes the generated electrons in the form of electricity. The terminals are adapted to connect each battery stack to a load; in essence, a system that utilizes the electricity generated in the cell. Some exemplary suitable terminal assemblies are disclosed in U.S. Pat. Nos. 8,357,469; 9,553,329; 9,685,677; 9,825,336; and US Patent Application Publication No.: 2018/0053926; incorporated herein by reference in their entirety for all purposes.

### ILLUSTRATIVE EXAMPLES

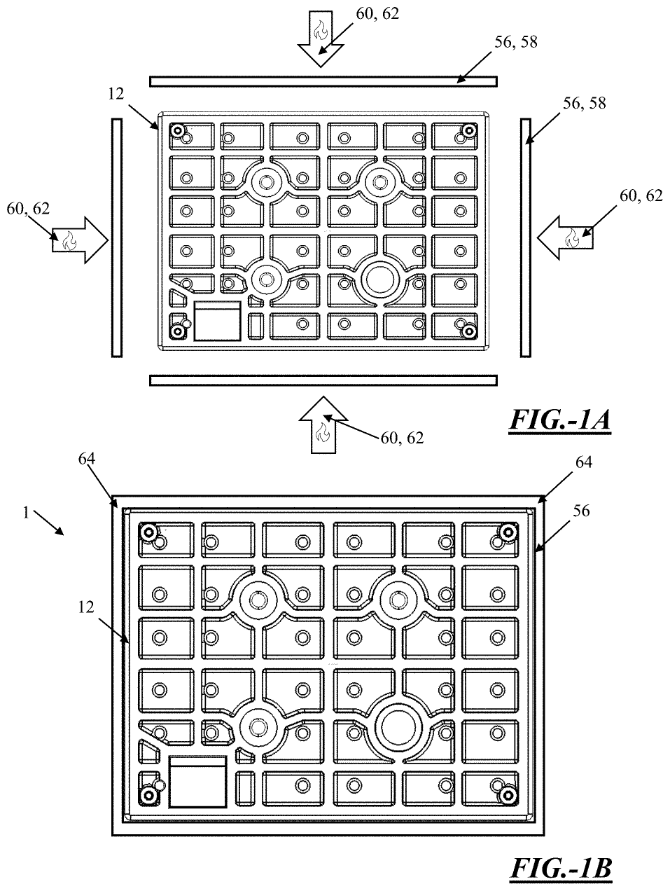

FIGS. 1A-1B illustrate a plan view of an electrode plate stack 12 having a membrane 56 applied thereon to form a battery assembly 1. The membrane 56 is formed by a plurality of membrane sheets 58. Each membrane sheet 58 is sized to fit a side of electrode plate stack 12 (e.g., approximately same width and length as a side). Each membrane sheet 58 and side of the electrode plate stack 12 is preheated via a heat source 60. The heat source 60 may be in the form of infrared heat 62. After being preheated, the membrane sheets 58 may be applied to each side of electrode plate stack 12. Due to being preheated, the membrane sheets 58 may conform to the contours of the exterior of the electrode plate stack 12. The membrane sheets 58 may be bonded at their edges 64 to form a unitary membrane 56.

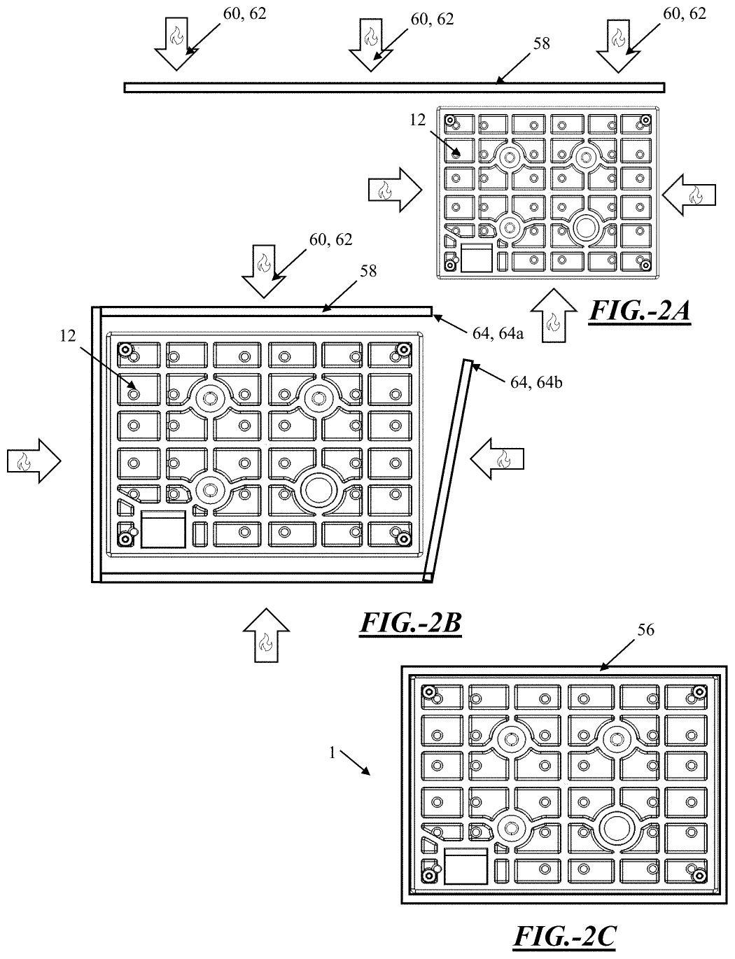

FIGS. 2A-2C illustrate a plan view of an electrode plate stack 12 having a membrane 56 applied thereon to form a battery assembly 1. The membrane 56 is formed by a unitary, single membrane sheet 58. The membrane sheet 58 and the electrode plate stack 12 are preheated via a heat source 60. The heat source 60 may be in the form of infrared heat 62. After being preheated, the membrane sheet 58 is applied and formed to each side of the electrode plate stack. The membrane sheet 58 includes two edges 64, a leading edge 64a and a trailing edge 64b. Due to being preheated, the membrane sheet 58 is able to bend and conform to the contours of the exterior of electrode plate stack 12. A heat source 60 may continue to be applied to bond the membrane sheet 58 to the electrode plate stack 12, bond the two edges 64 of the membrane sheet 58, or both to form the membrane 56 of a battery assembly 1.

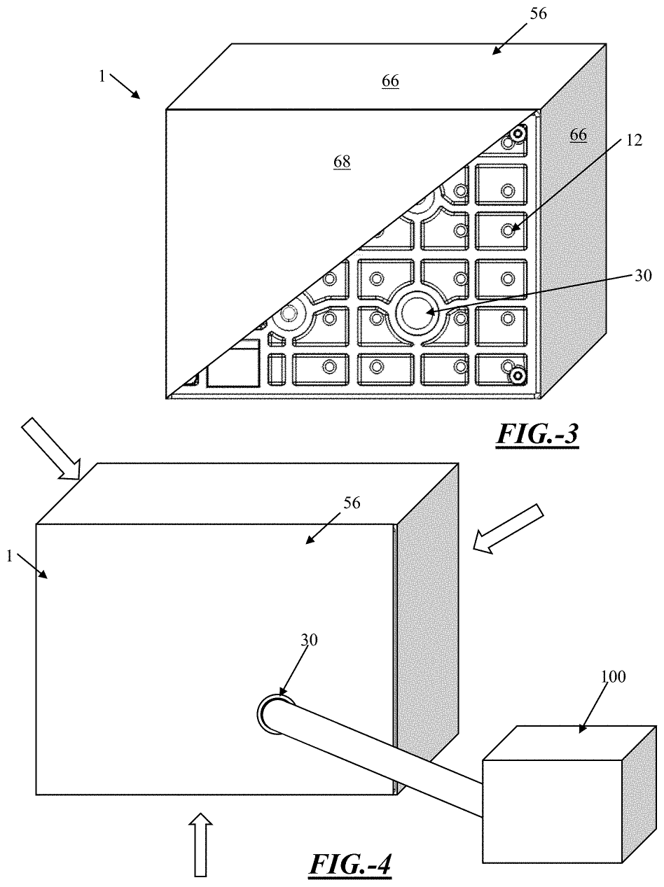

FIG. 3 illustrates a battery assembly 1 with a partially exposed view of an electrode plate stack 12. The battery assembly 1 includes a membrane 56. The membrane 56 covers both the side surfaces 66 and the end surfaces 68 of the electrode plate stack 12. As an alternative, the end surfaces 68 may be free of the membrane 56. The battery assembly 1 also includes a channel 30 which extends transversely through the electrode plate stack 12.

FIG. 4 illustrates a battery assembly 1 affixed to a vacuum pump 100. A vacuum pump 100 may be in fluid communication with a channel 30 of the battery assembly 1. The vacuum pump 100 may be capable of drawing a vacuum from the battery assembly 1. By drawing the vacuum, the membrane 56 may be drawn inward to form a conformed fit about the exterior of a electrode plate stack 12 (not shown). The vacuum may be drawn while the membrane is warm and pliable, such as from the application processes illustrated in FIGS. 1A-2C. Or the vacuum may be drawn without a heat application prior to. The space between the membrane 56 and the exterior of the electrode plates 12 may be in fluid communication via one or more vent holes 44 (not shown) and a vent channel 30a (not shown).

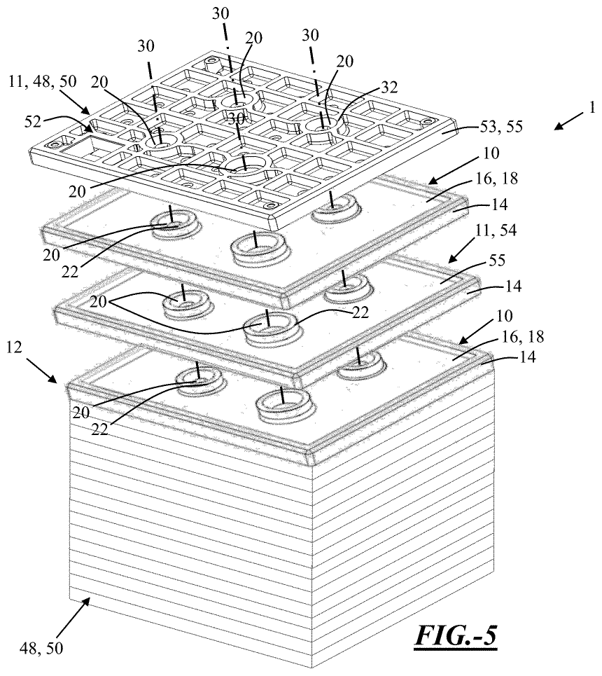

FIG. 5 shows a partially exploded electrode plate stack 12 which forms a battery assembly 1. The electrode plate stack 12 includes a plurality of electrode plates 11. The electrode plates 12 include opposing monopolar plates 48 at the ends of the stack and bipolar plates 54 therebetween. The electrode plates 11 are alternatingly arranged with separators 10, such that a separator 10 is located between each pair of electrode plates 11. Shown is an end plate 50 which is a monopolar plate 48. The end plate 50 includes an internal reinforcement structure 52. The monopolar plate 48 includes a plurality of openings 20. Each opening 20 is surrounded by an insert 22. The insert 22 is raised and projecting from a base 53 of the monopolar plate 48. The base 53 is also the substrate 56 of the monopolar plate 48. Adjacent to the monopolar plate 48 is a separator 10. The separator 10 includes a frame 14. The frame 14 forms a raised edge about the periphery of the separator 10. The frame 14 of a separator 10 may or may not extend completely outward to the periphery of the battery assembly 1. As an alternative, the separator 10 may be free of a frame 14 and/or a raised edge. If the separator 10 is free of a raised edge, the separator 10 may rest within a frame 14 of an adjacent electrode plate 11. The separator 10 includes a sheet 16. The sheet 16 may be a glass mat, such as an absorbent glass mat (AGM) 18. The sheet 16 is located in the interior and adjacent to the frame 14. The sheet 16 may be integral with the frame 14 or affixed thereto. The separator 10 includes a plurality of openings 20. Each opening 20 is at least partially surrounded by an insert 22. The insert 22 projects from the separator 10, such as from the sheet 16. As an alternative, the separator 10 may be free of any or all inserts 22 and only include openings 20. Inserts 22 of adjacent electrodes 11 may extend through the openings 20 of the separator 10. Adjacent to the separator 10 is a bipolar plate 54. The bipolar plate 54 includes a substrate 56 and a frame 14. The frame 14 forms a raised edge about the periphery of the substrate 55 of the bipolar plate 54. The bipolar plate 54 includes a plurality of openings 20. Each opening 20 is at least partially surrounded by an insert 22. The insert 22 projects from the substrate 55 of the bipolar plate 54. The inserts 22 and channel openings 20 align and the inserts 22 interlock to form one or more transverse channels 30 through the electrode plate stack 12. One or more of the transverse channels 30 can receive one or more posts 24 (not shown) therethrough, such that one or more posts 24 (not shown) extend through one or more of the transverse channels 30. The electrode plates 12 may include one or more active materials 70 (not shown) and/or one or more transfer sheets (not shown).

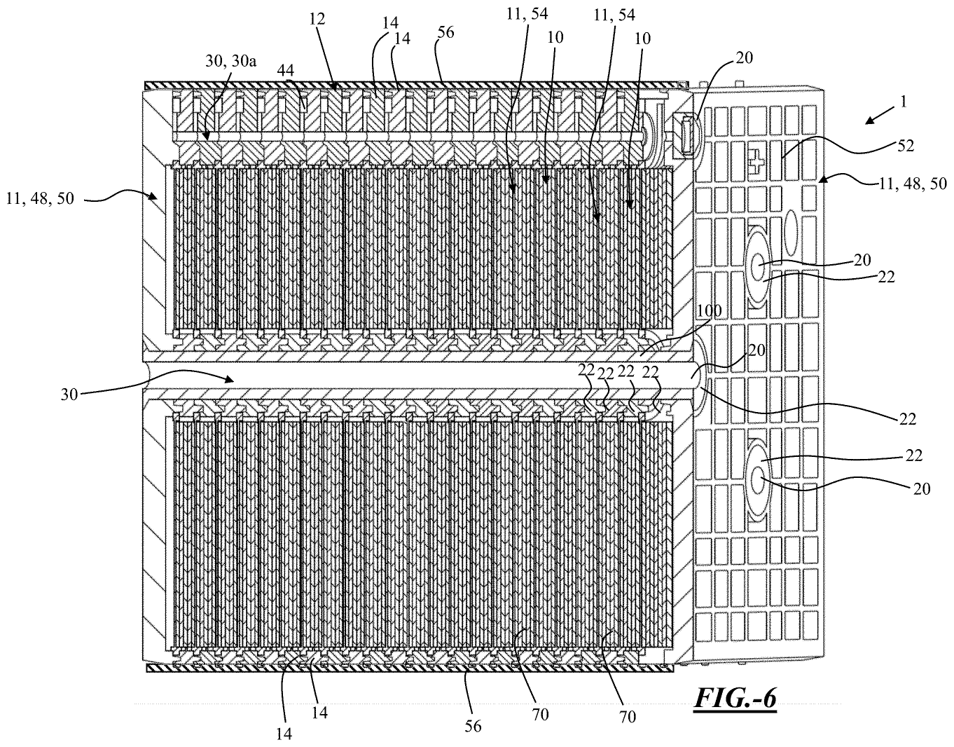

FIG. 6 illustrates a perspective view of a cross-section of a battery assembly 1. The battery assembly 1 includes an electrode plate stack 12. The electrode plates 11 include monopolar plates 48 located at opposing ends of a stack of bipolar plates 54. The monopolar plates 48 are end plates 50 of the battery assembly 1. The monopolar plate 48 includes an internal reinforcement structure 52. The electrode plates 12 each include a frame 14. The frames 14 are aligned and interlock with one another about the periphery of the battery assembly 1. Located about the exterior of the battery assembly 1 is a membrane 56. The membrane 56 is bonded to the outer periphery of the electrode plates 11, specifically the frames 14. Between each pair of electrode plates 12 is a separator 10. The electrode plates 12 include inserts 22. The inserts 22 are aligned and interlock with one another. The inserts 22 include openings 20 therethrough. The openings 20 are aligned to form the transverse channels 30. The transverse channels 30 extend transversely through the battery assembly 1. The transverse channels 30 pass through the electrode plates 12, the separators 10, the active material 70, and the electrolyte (not shown) located between pairs of electrode plates 11. One or more of the transverse channels 30 may have one or more posts 24 (not shown) extending therethrough. Some of the inserts 22 include vent holes 44. The inserts 22 with vent holes 44 may form a transverse channel 30 which is also a vent channel 30a.

### REFERENCE NUMBERS

1—Battery assembly, 10—Separator, 11—Electrode plates, 12—electrode plate stack, 14—Frame, 16—Sheet, 18—Glass mat, 2—Opening, 22—Insert, 24—Posts, 30—Channel, 30a—Vent channel, 44—Vent holes, 48—Monopolar plate, 50—End plate, 52—Internal reinforcement structure, 53—Base, 54——Bipolar plate, 55—Substrate, 56—Membrane, 58—Membrane sheet, 60—Heat source, 62—Infrared heat, 64—Edges, 64a—Leading edge, 64b—Trailing edge, 66—Side surface, 68—End surface, 70—Active material, 100—Vacuum pump

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed:

1. A method for forming a bipolar battery assembly comprising:
a) forming an electrode plate stack by stacking a plurality of electrode plates to create a plurality of electrochemical cells therebetween;
b) applying one or more membrane sheets to one or more exterior surfaces of the electrode plate stack such that the one or more membrane sheets conform to one or more contours of the one or more exterior surfaces and form a membrane of the bipolar battery assembly; and
wherein the method includes one or more of the following:
i) heating the one or more exterior surfaces of the electrode plate stack to form one or more preheated exterior surfaces prior to application of the one or more membrane sheets;
ii) heating the one or more membrane sheets to form one or more heated membrane sheets prior to application of the one or more membrane sheets; and/or
iii) drawing a vacuum from the electrode plate stack, after application of the one or more membrane sheets, to form fit the one or more membrane sheets to the one or more exterior surfaces to form the membrane.

2. The method of claim 1, wherein the heating of the one or more exterior surfaces, the one or more membrane sheets, or both are completed by one or more heat sources.

3. The method of claim 2, wherein the one or more heat sources include one or more convection heaters, one or more radiant heaters, or a combination thereof.

4. The method of claim 3, wherein the one or more heat sources includes one or more infrared heaters, one or more heat guns, or both.

5. The method of claim 2, wherein the one or more heat sources includes two or more heat sources, with at least one heat source associated with heating the one or more membrane sheets and at least another heat source associated with heating the one or more exterior surfaces.

6. The method of claim 2, wherein the one or more heat sources heat the one or more membrane sheets to between a glass transition temperature and a melting point of the one or more membrane sheets; and/or
wherein the one or more heat sources heat the one or more exterior surfaces to a temperature at or below a glass transition temperature of the one or more exterior surfaces.

7. The method of claim 1, wherein the one or more exterior surfaces, the one or more membrane sheets, or both are heated to a temperature of about 50° C. to about 275° C.

8. The method of claim 1, wherein the one or more membrane sheets are heated until softening and becoming flexible.

9. The method of claim 1, wherein the one or more membrane sheets are each comprised of a single layer or a plurality of layers of one or more membrane materials.

10. The method of claim 9, wherein the one or more membrane materials include one or more thermoplastics.

11. The method of claim 9, wherein the one or more membrane materials include polyethylene, polypropylene, ABS, polyester, or a combination thereof.

12. The method of claim 1, wherein the one or more membrane sheets include a plurality of membrane sheets; and
wherein each individual membrane sheet of the plurality of membrane sheets is sized to match a single side surface, end surface, or both of the electrode plate stack.

13. The method of claim 1, wherein the method includes bonding one or more edges of the one or more membrane sheets to one or more other edges of the one or more membrane sheets; and
wherein the one or more edges are a leading edge and a trailing edge of a single membrane sheet or wherein the one or more edges are adjacent edges of two or more membrane sheets.

14. The method of claim 1, wherein the forming of the electrode plate stack includes aligning and stacking the plurality of electrode plates such that one or more frames of one or more electrode plates align and interlock with one or more other frames of one or more adjacent electrode plates, separators, or both.

15. The method of claim 1, wherein the forming of the electrode plate stack includes aligning and stacking the plurality of electrode plates such that one or more inserts of one or more electrode plates align and interlock with one or more other inserts of one or more adjacent electrode plates, one or more adjacent separators, or both to form one or more channels passing through the electrode plate stack.

16. The method of claim 1, wherein the one or more membrane sheets are one or more laminates, composite laminates, or both.

17. The method of claim 16, wherein the method includes forming the one or more membrane sheets; and
wherein the forming of the one or more membrane sheets includes layering a plurality of membrane layers to form the one or more membrane sheets as the one or more laminates, composite laminates, or both.

18. The method of claim 1, wherein one or more heat sources are moved away from the one or more heated exterior surfaces, the one or more heated membrane sheets, or both prior to the applying of the one or more heated membrane sheets; or
wherein the method includes applying heat while applying the one or more membrane sheets to the one or more exterior surfaces.

19. The method of claim 1, wherein the method includes inserting the electrode plate stack and the one or more membrane sheets into a vacuum chamber, affixing a vacuum pump to one or more channels extending through the electrode plate stack, or both before, during, and/or after heating the stack; and
wherein the method includes evacuating about 1 psi or greater to about 13 psi or less from an interior of the electrode plate stack.

20. The method of claim 1, wherein the method includes cooling and solidifying the one or more heated membrane sheets to form the membrane; and
wherein the cooling and the solidifying occurs in an ambient environment, via air circulation, via fluid circulation, or any combination thereof.

21. The method of claim 1, wherein the method includes filling the plurality of electrochemical cells with an electrolyte, and wherein the electrolyte is a liquid electrolyte.
